(19) United States
(12) Patent Application Publication
(10) Pub. No.: US 2012/0143508 A1
(43) Pub. Date: Jun. 7, 2012

(54) AUTOMATIC ESTIMATION OF SOURCE ROCK PETROPHYSICAL PROPERTIES

(75) Inventors: James D. Klein, Tucson, AZ (US); Jesus M. Salazar, Houston, TX (US)

(73) Assignee: CONOCOPHILLIPS COMPANY, Houston, TX (US)

(21) Appl. No.: 12/958,088

(22) Filed: Dec. 1, 2010

(51) Int. Cl. G01V 3/18; G06F 19/00

(52) U.S. Cl. 702/7

(57) ABSTRACT

An empirical method of measuring water saturation in hydrocarbon bearing formations is described. The system described herein accurately calculates water saturation, shale volume, volume of total organic carbon, and other formation parameters under a variety of formation conditions.

### PRIOR RELATED APPLICATIONS

This application is a non-provisional application which claims benefit under 35 USC §120 to U.S. patent application Ser. No. 12/818,680, filed Jun. 18, 2010, entitled “Source Rock Volumetric Analysis,” which claims benefit under 35 USC §119(e) to U.S. Provisional Application Ser. No. 61/218,701 filed Jun. 19, 2009, entitled “Source Rock Volumetric Analysis,” both of which are incorporated herein in their entirety.

### FIELD OF THE DISCLOSURE

The present disclosure generally relates to methods and apparatus for determining a variety of fractional volumes associated with hydrocarbon accumulations; the knowledge of which being critical for the profitable extraction of hydrocarbons. Methods include quantifying water saturation (S_{W}), Porosity (POR), hydrocarbon pore volume (HPV), clay volume (VCL), total organic carbon (TOC), and crystalline matrix (VCRYS) volume fractions in source rocks and low permeability formations.

### BACKGROUND OF THE DISCLOSURE

Determining the characteristics for source rocks that enhance commercial exploitation requires knowledge of stored hydrocarbons and their accessibility from an individual wellbore. As the petroleum industry pursues unconventional resources (i.e. “tight” rocks and “source” rocks), conventional interpretation methods for determining formation characteristics become difficult and more complicated to apply successfully. Specifically, conventional interpretation of water saturation in subterranean formations first requires the determination of formation porosity, formation water resistivity, and empirical parameters which are then used in one of a variety of published empirically-derived water saturation equations. Determining the required empirical parameters is more difficult (and sometimes impossible) in unconventional reservoirs due to the very low permeability of these “tight” rocks. Also, since very little water is produced from these formations, the determination of formation water resistivity is also difficult. Furthermore, porosity measurements are very difficult without substantial lab work on core samples or extensive logging due to the complex mineralogy often encountered in source rocks. Finally, lab work to determine conventional empirical parameters is difficult because such tests require flowing fluids through the samples and their low values of permeability hinder one's ability to perform these tests. Since Archie's original observations were published in 1941, the focus of industry has been on predicting oil-in-place in typical reservoirs using porosity, formation water resistivity, and other related parameters.

Used in geology, hydrogeology, soil science, and building science, the porosity of a porous medium (such as rock or sediment) describes the fraction of void space in the material, where the void may contain, for example, air, water, or hydrocarbons. It is defined by the ratio:

φ=V_{V}/V_{T} (1)

where Phi (φ) is porosity, V_{V} is the volume of void-space (such as fluids), and V_{T} is the total or bulk volume of material, including the solid and void components. Porosity (φ) is a fraction between 0 and 1, typically ranging from less than 0.01 for solid granite to more than 0.5 for peat and clay. In some instances, porosity may also be represented in percent terms by multiplying the fraction by 100. Sedimentary porosities are a complex function of many factors, including but not limited to: rate of burial, depth of burial, the nature of the connate fluids, and the nature of overlying sediments (which may impede fluid expulsion). The porosity of a rock, or sedimentary layer, is an important consideration when attempting to evaluate the potential volume of water or hydrocarbons it may contain.

Volumetric water content, 0, is defined mathematically as:

θ=V_{W}/V_{T} (2)

where V_{W} is the volume of water and V_{T}=V_{R}+V_{V}=V_{R}+V_{W}+V_{H} is the total volume (that is Rock Volume+Water Volume+Hydrocarbon Volume). The term water saturation, S_{W}, is defined as

S_{W}=V_{W}/V_{V}=V_{W}/φV_{T}=θφ (3)

where θ is the volumetric water content and θ is the porosity. Values of S_{W} can range from 0 (dry) to 1 (saturated), although complete dehydration (S_{W}=0) does not occur under these rock conditions.

Total organic carbon (TOC) is the amount of carbon bound in solid organic components, not gas or liquid. A typical analysis for TOC measures both the total carbon present as well as the inorganic carbon (IC) contained primarily in carbonate minerals. Subtracting the inorganic carbon from the total carbon yields TOC. Another common variant of TOC analysis involves removing the IC portion first and then measuring the leftover carbon. This method involves purging an acidified sample with carbon-free air or nitrogen prior to measurement, and so is more accurately called non-purgeable organic carbon (NPOC).

Other researchers have attempted to calculate/estimate oil reserves using Archie's factors. Forgotson (U.S. Pat. No. 3,820,390) uses observed resistivity to calculate other variables in Archie's equation. Frenkel, et al. (U.S. Pat. No. 5,870,690) describe processing acoustic velocity and electrical resistivity well log data to model earth formations. Coates (U.S. Pat. No. 5,557,200) as well as Herron and Herron (U.S. Pat. No. 6,844,729) use downhole nuclear magnetic spectroscopy to measure a variety of properties including water saturation. Oraby (U.S. Pat. No. 5,668,369) uses neutron log information to calculate water saturation. Little and Lavigne (U.S. Pat. No. 7,363,164) solve the triple-water equation by measuring formation resistivity, volume, and conductivity of free water. Ramakrishnan (US20080215242) uses a resistivity tool in a borehole to directly measure resistivity. Dunham (U.S. Pat. No. 5,992,228) provides an improved model for moisture in soil analysis. Although a variety of methods have been developed to determine porosity, water saturation, and ultimately hydrocarbon content in a variety of substrates, they all require expensive equipment (NMR, neutron, and the like), complicated and detailed laboratory experiments, and are time consuming.

Problems with existing systems include required multiple downhole logging trips, complex and lengthy analyses and skilled analysis under laboratory conditions. Traditional porosity determination in source rocks requires abundant log data, core calibration and corrections due to the presence of organics and a wide variety of minerals. With analyses like Passey's (1990), a shale model is used that doesn't accurately reflect conditions in a source rock. Conventional approaches require that porosity be computed prior to water saturation, where inaccuracies in the former are easily passed on to the latter. Furthermore, additional error arises from having to assume—at minimum—values for Archie's cementation factor and water resistivity since obtaining these parameters from fluid-impervious matrices is difficult.

Assessing the accessibility of stored hydrocarbons in tight rocks requires knowledge of overall mechanical properties and the impact of hydraulic stimulation. Certain constituents commonly found within a source rock, including organic carbon, may enhance the stored volume of hydrocarbon while they hinder the ability to effectively stimulate production of valuable deposits. Other constituents such as clays often found in source rocks also reduce the effectiveness of hydraulic stimulation. Determination of the volume of clay, TOC and more brittle mineral components (crystalline matrix) is critical for commercial exploitation, but calculating TOC, clay and brittle minerals conventionally requires abundant log and core data for calibration.

Using a traditional approach is burdensome, error prone, and requires corrections to produce reliable results. This complicated and intensive process hinders automation, speed and empirical analysis of the hydrocarbon content. A new method is required that can quantitatively calculate multiple reservoir parameters quickly with relatively limited sampling.

### BRIEF DESCRIPTION OF THE DISCLOSURE

A new automated method is described that utilizes minimal data, minimal assumptions and fewer operations to compute water saturation (S_{W}); porosity; volume of organic carbon; and volume of clay in source rocks. While founded in the original observations introduced by Archie (1941) which have become the foundation of petrophysics, the new method requires no knowledge of formation water resistivity (R_{W}), porosity or cementation (m) to compute R₀ for the native formation. Once R₀ is calculated, the basic Archie equation for S_{W} can be rearranged to solve for a variety of both native and non-native rock properties including saturation, porosity, total organic carbon, bulk volume hydrocarbon, clay volume, void space, and the like. The disclosed invention provides important hydrocarbon volumetric characterization in addition to other parameters critical for efficient exploitation of source rock hydrocarbons.

A simple procedure with minimal laboratory analysis quickly and accurately assesses water saturation in hydrocarbon bearing formations. The method minimizes the number of downhole samples required and provides rapid results on location without requiring detailed laboratory analysis. This quantitative method of measuring water saturation in hydrocarbon containing formations identifies the combined electro-mechanical trend of subterranean formations that are 100% filled with water and free from hydrocarbon. A mathematical formula is empirically fit to this trend and used to calculate the electrical property, resistivity (R_{T}), for any observed mechanical property when the formation is assumed to be 100% water-filled (“R₀”). Once R₀ is determined, Archie's equation (Eq. 6) may be used to relate R_{T} and R₀ to determine S_{W}. A typical form of this equation would be: S_{W}=(R₀/R_{T})^{1/n} where S_{W} is water saturation, R₀ is resistivity at a 100% water saturation, R_{T} is true formation resistivity, and n is Archie's saturation exponent.

In one embodiment, a computer readable medium processes well log data through the following procedure:
a) fit a trend in a crossplot of resistivity against one or more formation porosity indicators to obtain 100% water-saturated resistivity (R₀),
b) automated regression process for resistivity against a porosity log to determine 100% saturation (S_{W}=100%),
c) calculate water saturation for the entire well using S_{W}=(R₀/R_{T})^{1/n},
d) verify regression results and S_{W} error where S_{W} yields a prominent mode equal to 100%,
e) compute shale volume (VSH) from R₀,
f) solve for porosity (φ) where φ=(R_{W}/S_{W}ⁿ R_{T})^{1/m},
g) determine R_{W},
h) identify common matrix values representing the common minerals present in sedimentary basins, and
i) determine total organic carbon.

In another embodiment, a method for determining well log parameters is described through the following procedure:
a) fit a trend in a crossplot of resistivity against one or more formation porosity indicators to obtain 100% water-saturated resistivity (R₀),
b) automated regression process for resistivity against a porosity log to determine 100% saturation (S_{W}=100%),
c) calculate water saturation for the entire well using S_{W}=(R₀/R_{T})^{1/n},
d) verify regression results and S_{W} error where S_{W} yields a prominent mode equal to 100%,
e) compute shale volume (VSH) from R₀,
f) solve for porosity (φ) where φ=(R_{W}/S_{W}ⁿ R_{T})^{1/m},
g) determine R_{W},
h) identify common matrix values representing the common minerals present in sedimentary basins, and
i) determine total organic carbon.

The computer readable medium or method may include analysis of matrix values in non-shale formations where VSH is less than 50%. Non-shale formations include sandstones with a matrix density and velocity of about 2.65 to 2.68 g/cc and 55.5 to 56.5 psec/ft, limestones with a matrix density and velocity of about 2.71 to 2.73 g/cc and 51 to 53 pec/ft, and dolostones with a matrix density and velocity in the range of 2.78 to 2.85 g/cc and 47 to 51 μsec/ft.

In some cases steps (e) and (f) are repeated to select an R_{W} value within an expected values. In another embodiment, crossplots can be resistivity against compressional slowness, resistivity against neutron porosity, resistivity against density and resistivity against NMR.

In some embodiments, the regression is a preliminary regression using a constrained hyperbolic function. In other embodiments the hyperbolic function parameters are derived statistically from resistivity and compressional slowness statistical distributions with their corresponding crossplot. Shale and clean reference values may be selected from the minimum and maximum statistical modes visible in the distribution of the “R₀” values. R_{W} may be determined by fitting core data, solving the density-porosity equation for matrix density, or solving a sonic-porosity equation for matrix velocity.

### BRIEF DESCRIPTION OF THE DRAWINGS

A more complete understanding of the present invention and benefits thereof may be acquired by referring to the follow description taken in conjunction with the accompanying drawings in which:

FIG. 1: Plot of Acoustic Compressional Slowness (DT) vs. Resistivity. The native formation ( [symbol] ) is shown in the arc, while areas of predominantly hydrocarbon ( [symbol] ), saltwater ( [symbol] ) or fresh water ( [symbol] ) can be easily identified and characterized once R₀ is calculated.

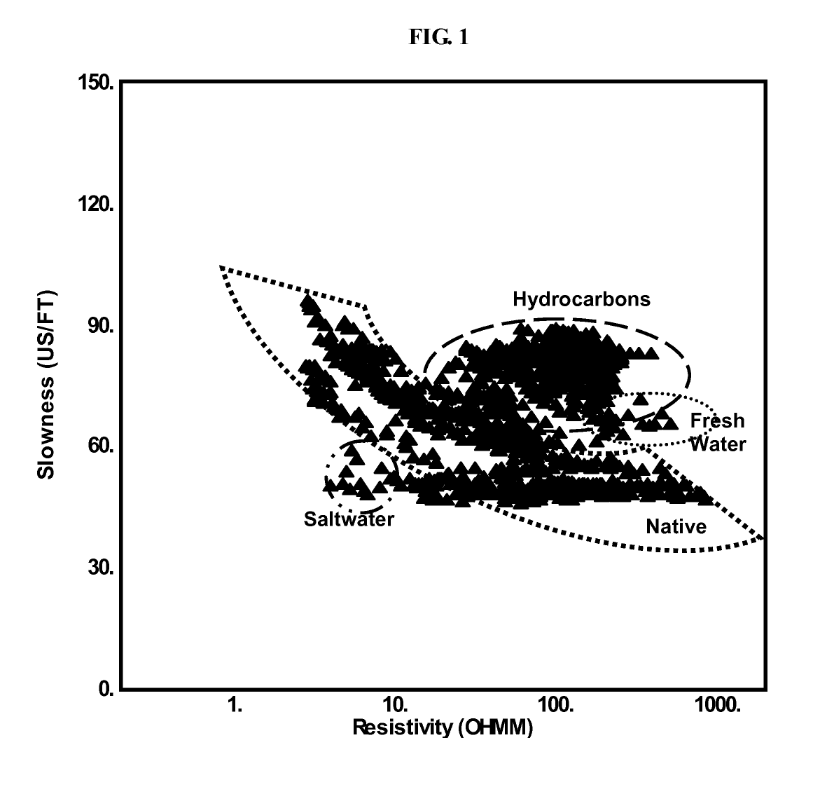

FIG. 2A: Resistivity-Sonic (DT) and FIG. 2B: Resistivity-Neutron (NPHI) using a Bleasdale type curves for average, max (+), and min (−) coefficients. The solid black curve was calculated using the average coefficients, remaining curves are calculated by keeping two coefficients as the average and modifying individual variables across a range of default values.

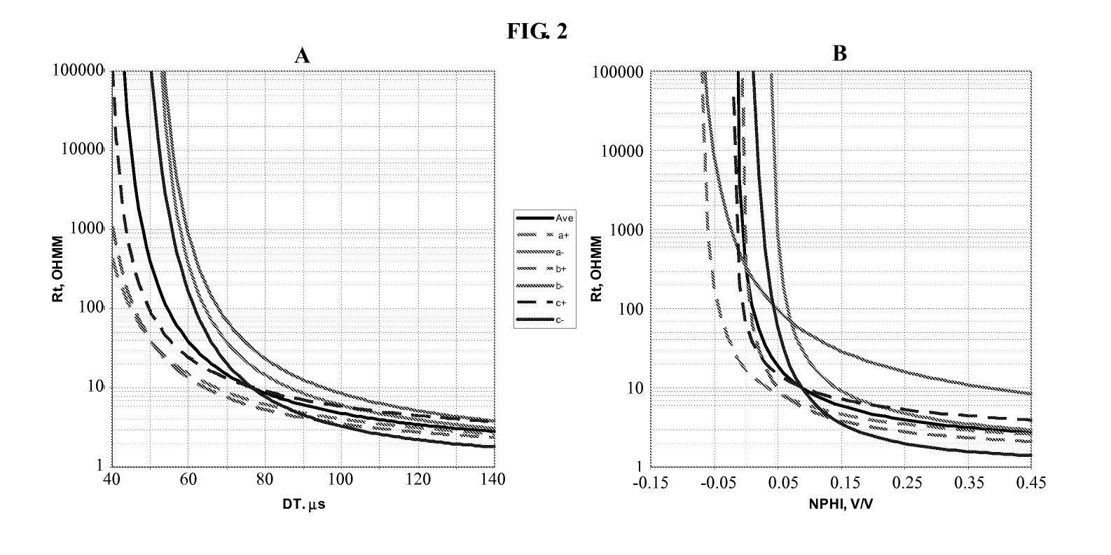

FIG. 3A: Resistivity-Neutron Harris and FIG. 3B: Heat Capacity type curves for average, max (+), and min (−) coefficients. The solid black curve was calculated using the average coefficients, remaining curves are calculated by keeping two coefficients as the average and modifying individual variables across a range of default values.

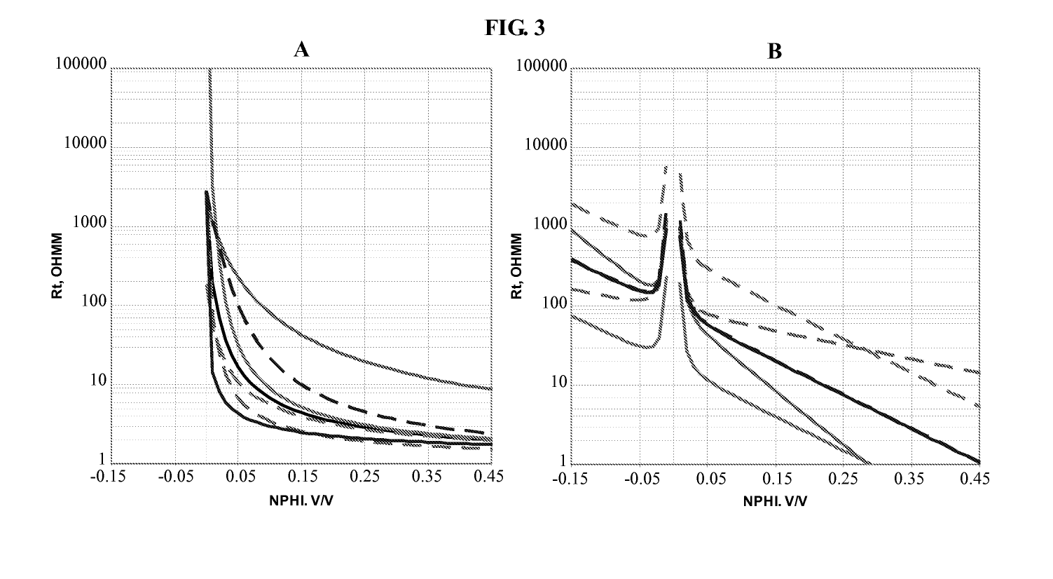

FIG. 4: Resistivity vs. compressional slowness for Formation III showing regressed equation for “R₀.”

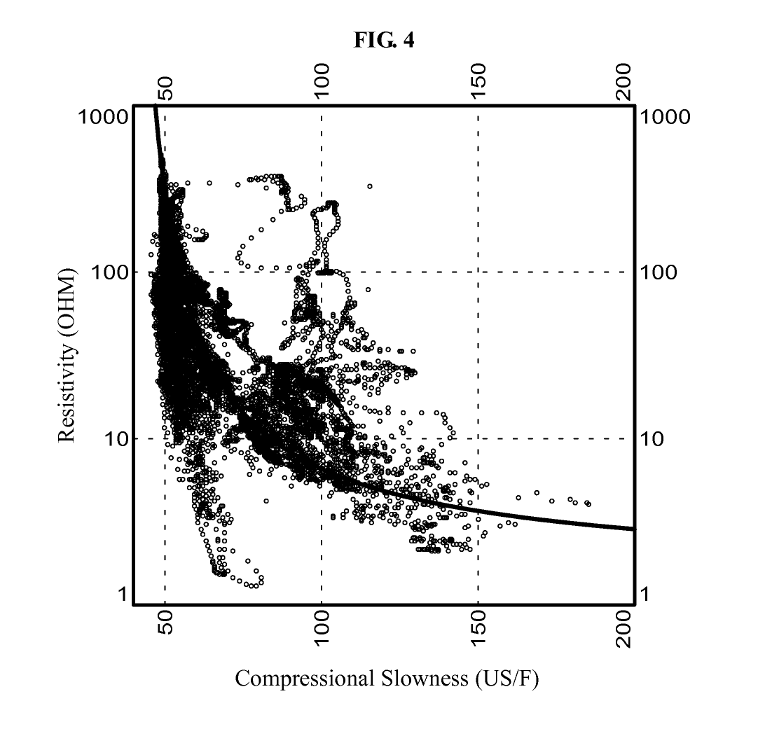

FIG. 5: Resistivity vs. compressional slowness for Formation II showing regressed equation for “R₀.”

FIG. 6: Valid calculations of S_{W} for Formation II as verified by the presence of a statistical mode peak at the theoretical S_{W}=100% value.

FIG. 7: Matrix density for final check of porosity calculation (R_{W} selection) for Formation II showing a matrix density range between 2.59 and 2.79 g/cc. Only data with less than 50% shale volume (VSH<50%) are shown.

### DETAILED DESCRIPTION OF EMBODIMENTS OF THE INVENTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present invention provides a simple quantitative method of calculating water saturation. Also provided is a system for processing borehole measurements to provide quantitative estimations of porosity (POR, Phi or φ), crystalline matrix volume (Vol), grain density (RhoG), shale volume (VSH), total organic carbon (TOC), and other saturation dependent variables. The method comprises acquiring resistivity and one or more porosity measurements available through standard well log procedures including compressional slowness, any one of the many neutron logging techniques, bulk density, nuclear magnetic resonance (NMR), and the like. Using standard plotting and analysis software, resistivity is plotted against one or more porosity dependent measurements to obtain a best fit for all of the saturation dependent variables thus allowing a quantitative estimation of water saturation to achieve an accurate description of the reservoir characteristics.

Abbreviations and well logging measurements include, Spectroscopy Gamma Ray (HSGR), Computed GR (HCGR), Spontaneous Potential (SP), Caliper (CALI), Bulk Density QC (BDQC), Line tension (TENS), Density Porosity (DPHI), Calibrate Downhole Force (CDF), Delta T Compressional (DTCO), Delta T Shear (DTSM), as well as other abbreviations and terms used for reservoir properties.

Shale volume (VSH) is a measure of shale content in a formation. Shale content ranges from no shale (0) to all shale (1). Shale content is an indication of organic content and may be measured directly through a variety of techniques or calculated from various formation properties. Shale content may also be indicative of the type of hydrocarbons, with natural gas hydrocarbons present at higher shale content and hydrocarbon oils present at lower shale content.

“Native” as used herein is a waterbearing, 100% saturated formation. This water-saturated formation represents the majority of subsurface formations in sedimentary basins. Observations of resistivity in numerous sedimentary formations around the world have shown that the majority of the rock within any formation is water-saturated or native rock. Once the resistivity for the “native” condition has been identified, volume properties within the formation can be determined.

“Non-native” as used herein identifies hydrocarbon bearing formations that contain hydrocarbon through either migration or formation in situ. Other formations found within the sedimentary basin include salt-water or fresh-water reservoirs. Properties of the “non-native” formations can be calculated using the resistivity values for the “native” formation previously calculated through empirical fitting of the native formation.

“Resistivity” is a measure of how strongly the formation opposes the flow of electrical current. Resistivity can be measured using any number of downhole tools including galvanic, induction, and electromagnetic logging tools. Resistivity may be measured anywhere from 1 Hz to 10 MHz. Commonly, resistivity is measured at about 10 kHz, 20 kHz, 30 kHz, 40 kHz, 50 kHz, 400 kHz, 500 kHz, 1 MHz, 2 MHz and combinations thereof. Resistivity may be measured at 2 or more frequencies simultaneously to measure a variety of ranges and properties around the well. Induction, laterlog, dual induction, dual laterlog, array induction, array laterlog, microresistivity, phasor, high resolution arrays, multicomponent induction, microscanner, dipmeter, microimager, and other types of well logging methods may be used to accurately measure resistivity under a variety of conditions at a variety of distances, on different scales, in unique planes (horizontal, vertical, spherical, arc or other geometry), with directionality (up or down) and/or anisotropy around the wellbore.

Other well properties may be plotted with resistivity to identify the “native” formation and to provide additional information regarding rock properties including density, porosity, lithology, radioactivity, and the like which may be measured using sonic, density, neutron, gamma ray, NMR, spontaneous potential, or other logs. These logs provide direct measures of rock properties and they may be used to calculate a variety of physical properties that characterize the rock. Because most types of logs are affected by changes in well diameter, caliper logs are essential to guide the interpretation of other logs.

The empirical method exploits the increased likelihood that ultra-tight, non-reservoir, immature (or non-source) rocks will be found in their native condition of S_{W}=100%. Such low permeability rock, which constitutes the majority of formation types found in the subsurface, requires extremely high capillary displacement pressure in order for migrating hydrocarbons to displace the water and take up residence in the pore spaces. Generating these high displacement pressures with gravity-driven buoyancy often requires continuous hydrocarbon columns to a depth that is greater than the depth of the sedimentary basin. Additionally, containment of such extreme pressures via a cap rock or seal would require rock strengths not observed in nature. Therefore, an abundance of low permeability rocks will be observed in their native water saturation condition of 100% unless hydrocarbons were generated within the rocks themselves. The empirical observations made by Archie describe saturation as proportional to a root of the ratio of the resistivities—(a) fully saturated or wet rock resistivity (R₀) and (b) measured formation resistivity (R_{T}). Many of the well-known electrical saturation calculations function through this primary relationship by calculating R₀ from more elusive parameters. Fortunately, since R₀ equals R_{T} for ultra-tight, non-source (or immature) rocks at native state, this primary Archie relationship can be exploited directly for determining S_{W}. Whenever a saturation-independent log such as velocity, gamma ray, neutron porosity or sonic compressional slowness, (DT), is plotted against resistivity (R_{T}), a clear trend of the native condition becomes visible even when many lithologies or long intervals are included. The new method employs curve-fitting techniques to compute R₀ from a saturation-independent parameter (x).

Typical abbreviations include water saturation (S_{W}), wet rock resistivity (R₀), wet rock sonic slowness (DTO), total porosity (PHIT), bulk density (RHOB), volume of total organics (VTOC), bulk volume water (BVW), upper boundary for resistivity (R0H), lower boundary for resistivity (R0L), and initial R₀ (R0_INI), as well as other well log parameters that may be graphed.

In unconventional reservoirs, specifically source rocks, RT is plotted against another saturation-independent empirical measurement, including velocity, compressional slowness, neutron porosity, or the like. The equation R₀=10^{(1/α)} is fit to the empirical data to determine R₀ for the native formation. R₀ is then used in a variety of modified equations to directly calculate water saturation independent of porosity, density, lithology, or any of the many previously required empirical parameters. The disclosed invention may use a wide variety of mathematical formulas to calculate “non-native” properties from the empirically fit R₀ observation in the native rock.

R₀ for the native formation is fit to the empirical data using a parameter (a) that best fits the native resistivity values using the equation:

R₀=10^{(1/α)} (4)

Log₁₀ R₀=1/α (5)

Once R₀ is calculated for the native formation, S_{W}, or any of the variety of known water saturation equations can be solved to mathematically calculate properties of the non-native formations. Previously, a variety of assumptions and measurements were required to compute S_{W} in this fashion since the difficult-to-obtain parameters (m, n, and R_{W}) are still required. To remedy the potential for errors from incorrect assumptions, the disclosed method provides a system of checks and balances that draw upon well known physical properties to constrain the calculated porosity. Specifically, measured formation bulk density and compressional slowness can be combined with the computed porosity using a variety of known physical relationships to derive a mineral matrix density or mineral matrix velocity for the sedimentary rock. When the assumptions are correct, the computed mineral matrix properties will be in line with known values in known sedimentary rock types. Alternatively, R_{W} and n may be directly measured with S_{W} and φ_{T} from core data to confirm the model data accurately reflect source rock conditions.

Since S_{W} is a function of porosity, an S_{W} equation can be rearranged to determine porosity directly. The same assumptions traditionally needed to compute S_{W} will be needed to compute porosity; however, the entire process has been simplified and those assumptions are not carried through S_{W} to other calculations. Additionally, the Passey method (1990), a widely-used source rock evaluation technique for quantifying total organic carbon, becomes more robust when using the DeltaLogR calculated from R₀ and R_{T} directly. Using the log of R_{T} minus the log of R₀ with the Passey workflow in place of DeltaLogR reduces or eliminates erroneous TOC values calculated in clay-poor formations. The disclosed invention also provides a new method for determining TOC volume directly, independent of all existing methods.

Archie demonstrated S_{W}, the fraction of pore space filled with water, to be proportional to the n^{th} root of the ratio of resistivities R₀ and R_{T}. For source rocks, the deviation in resistivity over and above the value of the native condition, R₀, is attributed to the fact that organic matter has produced fluid hydrocarbons and those fluids have displaced native formation water. Indirectly, it is the product of both the existence of TOC and its maturation that results in the resistivity effect exploited above. In accordance with observations made by Passey, as well as with compressional slowness modeling of formations using existing methods, TOC content within the matrix can significantly increase the compressional slowness of source rocks. In essence, resistivity is controlled by the fraction of pore space containing hydrocarbon, or, inversely, conductivity is controlled by the fraction of pore space containing water, while compressional slowness is controlled by the fraction of matrix that is TOC. What was true for water saturation and resistivity should also be true for the fraction of the rock matrix that is not TOC. TOC should be proportional to the n^{th} root of the ratio of compressional slowness D_{T0} and D_{T}. D_{T0} represents the TOC-free compressional slowness as determined from the electromechanical properties exploited for water saturation trend when starting with a known resistivity and D_{T} represents the observed compressional slowness. Empirical data does in fact reveal this to be the case; rendering the volume of TOC for a formation directly determinable—or as determinable as water saturation—from the above mentioned resistivity-sonic crossplot. Relative shale volume may also be computed using the generated “R₀” curve.

Computer automation of the calculations applied by a non-specialist allows wide-spread, highly-efficient hydrocarbon identification, quantification and mapping. Such capabilities should give the user a competitive advantage in exploration-related activities due to enhanced speed and fewer data requirements for evaluation.

In order to efficiently and accurately calculate hydrocarbon content across source rock in a defined area, several steps are undertaken to empirically measure saturation, porosity, resistivity and total organic carbon in the formation by plotting resistivity against another property, including but not limited to slowness, neutron porosity, or other property, and fitting an empirical equation to the observed primary trend for water-wet non-reservoir rocks
1. Calculate 100% water-wet resistivity (R₀) for native formation from empirical data for R₀=10^{(1/α)} where:

α=(a+bx^{c})^{d}[general],

α=(a+bx)^{1/c}[for resistivity vs DT or NPHI],

α=(a+bx^{1/c})[for resistivity vs neutron], or

α=(a+bx+c/x²)⁻¹[for resistivity vs neutron]
2. Calculate water saturation (S_{W}) from resistivity where:

S_{W}=(R₀/R_{T})^{1/n}
3. Verify S_{W} calculation by observing the statistical mode of all intervals.
4. Repeat steps 1-3 modifying a, b and/or c as required.
5. Calculate reservoir properties by reversing existing saturation equations where:

φ_{T}=(R_{W}/S_{W}ⁿ·R_{T})^{1/m}.
6. Verify reservoir parameters
   Select R_{W} value that fits observed porosity in core
   (R_{W} is approximately constant in tight rocks across broad regions)
   Reverse existing porosity equations and
   Confirm observed mineral matrix densities where:

θ=(Rhoₘ−Rho_{b})/(Rhoₘ−Rho_{f})
7. Calculate change in (D_{T0}) from resistivity sonic trend
   Plot R_{T} against velocity, solve for y (velocity, compressional slowness, etc.) where:

y=(a+bx)^{1/c}=D_{T0}
8. Calculate bulk volume total organic carbons (V_{TOC})

Vol_{TOC}=(1−(D_{T0}/D_{T})^{1/n})·(1−θ_{T})

Because a, b and c are empirically selected they may change from field to field, but the properties of native source rock within a formation can be identified and fit empirically for the entire formation. This allows calculation of the remaining formation properties in native or non-native formations to accurately determine saturation values, porosity values, resistivity values, total organic carbon content, bulk volume hydrocarbons and the like. One or more of these values may be determined depending on the information required and equations used for calculations.

Simple measurement of one or more porosity dependent values provides the limited data required to solve the water saturation problem. Archie's equation (1941) for water saturation is:

$${S}_{w} = {( {R}_{0} / {R}_{T} )}^{1 / n} = \sqrt[n]{\frac{{R}_{w}}{{Φ}^{m} \times {R}_{T}}} \qquad ( 6 )$$

Where S_{W} is water saturation, φ is the porosity, m is Archie's cementation exponent, R_{W} is the resistivity of water, R_{T} is the true formation resistivity, and n is the saturation exponent. The method described herein simplifies source rock φ and S_{W} calculations, improves existing TOC methods, requires less data, matches core samples, and is perfectly suited for exploration reconnaissance, business development and acquisition & divestiture.

With fewer data requirements and algorithms for automation, the disclosed invention can aid in exploration, asset acquisition and land acquisition activities by providing rapid quantification of porosity, water saturation and TOC from digital log data. The following equations may be manipulated along with simple well log data to determine complex formation properties.

### Bleasdale Type Equation, for Velocity (R₀) Vs Time (DT).

$$\begin{matrix}{R}_{o} = {10}^{\frac{1}{{( a + b \cdot DT )}^{1 / c}}} , & ( 7.1 ) \\ {DT}_{o} = \frac{1}{b} [ \frac{1}{{( log ( {R}_{t} ) )}^{c}} - a ] . & ( 7.2 )\end{matrix}$$

### Bleasdale Type Equation, for R₀ Vs NPHI.

$$\begin{matrix}{R}_{o} = {10}^{\frac{1}{{( a + b \cdot NPHI )}^{1 / c}}} , & ( 8.1 ) \\ {NPHI}_{o} = \frac{1}{b} [ \frac{1}{{( log ( {R}_{t} ) )}^{c}} - a ] . & ( 8.2 )\end{matrix}$$

Harris Type Equation, for R₀ Vs NPHI.

$$\begin{matrix}{R}_{o} = {10}^{\frac{1}{{( a + b \cdot NPHI )}^{1 / c}}} , & ( 9.1 ) \\ {NPHI}_{o} = {( \frac{1}{b} [ \frac{1}{log ( {R}_{t} )} - a ] )}^{1 / c} . & ( 9.2 )\end{matrix}$$

Heat Capacity Type Equation, for R₀ Vs NPHI.

$$\begin{matrix}{R}_{o} = {10}^{a + b \cdot NPHI + \frac{c}{{NPHI}^{2}}} , & ( 10.1 ) \\ a + b \cdot {NPHI}_{o} + \frac{c}{{NPHI}_{o}^{2}} - log ( {R}_{t} ) = 0 , & ( 10.2 )\end{matrix}$$

where Rₜ and R₀ are true formation and wet rock resistivity, DT and DT, are acoustic slowness in the formation and in a wet rock, and NPHI and NPHIₒ are the neutron response in the formation and in wet rock, respectively. The coefficients a, b, and c are dependent of the data set. Such coefficients are different for each model. Equation (10.2) is a non-linear equation, Newton Method is used to find NPHIₒ.

In one or more embodiments the following programs may be used to analyze the data including: Sonic: Program SHALE_RT_DT_Bleas; Neutron: Program SHALE_RT_NPHI_Bleas; Neutron: Program SHALE_RT_NPHI_Harris; Neutron: Program SHALE_RT_NPHI_HeatCap. The program used depends upon the data available, quality of the data and desired properties to be measured.

The Sonic Program SHALE_RT_DT_Blease simply codifies the Bleasdale Type Equation for velocity (R₀) vs time (DT). Similarly, SHALE_RT_NPHI_Bleas codifies the Bleasdale Type Equation for velocity (R₀) vs NPHI, SHALE_RT_NPHI_Harris codifies the Harris Type Equation for velocity (R₀) vs NPHI, and SHALE_RT_NPHI_HeatCap codifies the Heat Capacity Type Equation for velocity (R₀) vs NPHI. These programs fit raw data measurements from downhole sonic, neutron, and/or other well logging equipment.

In one embodiment, one or more of the programs are fit to the existing well log data (RT vs DT). The program may analyze data across the reservoir, or the user may select specific depths for analysis. One or more of the programs, Sonic or Neutron Bleasdale, Neutron Harris, or Neutron Heat Capacity type equations are run across the selected data. The program runs one or more iterations, and frequently may run several iterations, until the modeled curvature (R₀) agrees with the field data. Bootstrapping may be done to improve the match by inputting the final answer from an initial run as the initial parameters for a subsequent run. The subsequent run may have a narrower range, forcing the next set of final parameters to better align with the data. As the data and the model approach a single result, the range may approach zero. Note that setting the data range at zero with not provide the best fit because the model is not flexible enough to match the data.

The following examples of certain embodiments of the invention are given. Each example is provided by way of explanation of the invention, one of many embodiments of the invention, and the following examples should not be read to limit, or define, the scope of the invention.

### Example 1

### Stochastic Implementation for Rt/Sonic in GEOLOG®

These programs calculate Volume of Total Organic Carbon (VTOC), Porosity (PHIT), and Water Saturation (S_{W}), among other variables in shale gas rocks. It uses an approach that fits a previously selected type curve in the Rₜ vs. DT or Rₜ vs. NPHI crossplots. The only necessary inputs are deep resistivity and sonic or neutron logs along with several constants that depend on the model to be used. In one embodiment a stochastic curve fit was implemented using a LOGLAN code for GEOLOG® programming language (PARADIGM® Ltd., George Town, Cayman Islands). In another embodiment, the stochastic curve fit was adapted to C++ codes to run automatically in the Interactive Petrophysics (IP) 3.4 platform. In either implementation the curve fit with basic data was able to identify the best fit and reservoir properties for the underlying formation.

Because the model only requires two inputs, deep resistivity and a sonic or neutron log with constant seed values for a, b, and c, it is very robust and can obtain accurate estimations of reservoir properties with minimal input. Based upon a variety of shale gas datasets, coefficients for a, b, and c, were estimated with different models in Table 1:

TABLE 1
Estimation of coefficients as determined by empirical data

| | | DT Bleasdale | | | NPHI Bleasdale | | | NPHI Harris | | | NPHI Heat Capacity | | |
|---|---|---|---|---|---|---|---|---|---|---|---|---|---|
| | | a | b | c | a | b | c | a | b | c | a | b | c |
| Formation I | DR | −0.780 | 0.015 | 0.787 | 0.025 | 5.364 | 2.939 | 0.251 | 1.783 | 0.505 | 2.095 | −5.388 | 1.19E−06 |
| Formation II | GU3 | −0.612 | 0.014 | 1.602 | | | | −2.220 | 3.068 | 0.042 | 1.976 | −1.864 | 0.0002 |
| Formation III | F1 | −0.497 | 0.010 | 3.085 | | | | −0.298 | 1.192 | 0.150 | 2.176 | −3.030 | 0.00021 |
| Formation IV | CE | 0.241 | 0.011 | 0.284 | 0.028 | 5.322 | 3.358 | 0.345 | 1.751 | 0.571 | | | |
| Formation V | NW | −0.194 | 0.014 | 0.600 | 0.082 | 2.345 | 2.126 | 0.270 | 1.352 | 0.641 | 2.134 | −3.542 | 0.00025 |
| Formation VI | JWA | −1.666 | 0.038 | 1.376 | 0.395 | 9.131 | 0.804 | 0.315 | 12.478 | 1.068 | | | |
| Formation VII | K2 | −1.626 | 0.041 | 0.650 | 0.106 | 19.821 | 1.411 | 0.160 | 8.534 | 0.749 | 1.206 | −4.862 | 8.99E−05 |
| Formation VIII | EG | −2.907 | 0.062 | 1.221 | 0.204 | 10.382 | 1.334 | 0.297 | 6.043 | 0.840 | 1.374 | −4.018 | 1.81E−06 |
| Formation IX | AD | −0.464 | 0.024 | 1.371 | 0.249 | 18.150 | 1.314 | 0.347 | 9.744 | 0.853 | | | |
| Formation X | RTC | −1.061 | 0.027 | 1.017 | 0.486 | 2.403 | 0.664 | 0.342 | 4.018 | 1.161 | 2.588 | −7.066 | 7.38E−06 |
| AVERAGE | — | −0.9566 | 0.026 | 1.199 | 0.197 | 9.115 | 1.74375 | −0.0191 | 4.996 | 0.658 | 1.936 | −4.253 | 0.0001 |

Initial coefficients could be further refined by determining sensitivity of each equation to the parameters under a variety of conditions. By determining maximum and minimum sensitivity values for each coefficient, faster and more reliable values could be determined for each set of conditions. The recommended values for each coefficient are provided in Table 2. These ranges of tolerance provide a rapid and accurate starting point for each equation. The coefficients are estimated and the ranges can be reduced until they approach, but do not reach, zero. In this way the match, fitted coefficients to actual data, may be confined and a more precise fit determined.

TABLE 2
Recommended Default Values for each model

| Model | Coef | Average | Max (+) | Min (−) | Range± |
|---|---|---|---|---|---|
| DT Bleasdale | a | −0.956 | −0.706 | −1.206 | 0.25 |
| | b | 0.026 | 0.031 | 0.021 | 0.005 |
| | c | 1.20 | 1.70 | 0.70 | 0.5 |
| NPHI Bleasdale | a | 0.197 | 0.697 | −0.303 | 0.5 |
| | b | 9.11 | 16.11 | 2.11 | 7 |
| | c | 1.74 | 2.74 | 0.74 | 1 |
| NPHI Harris | a | 0.291 | 0.441 | 0.141 | 0.15 |
| | b | 5.71 | 9.96 | 1.46 | 4.25 |
| | c | 0.80 | 1.10 | 0.50 | 0.3 |
| NPHI Heat | a | 1.94 | 2.64 | 1.24 | 0.7 |
| | b | −4.25 | −1.75 | −6.75 | 2.5 |
| | c | 0.0001 | 0.0001 | 0.0001 | 1E−05 |

A system of checks and balances that draw upon well known physical properties constrain the calculated porosity. In one embodiment, measured formation bulk density and compressional velocity are combined with the computed porosity to derive a mineral matrix density or mineral matrix velocity of the sedimentary rock. Realistic estimates place the computed mineral matrix properties within known values in known sedimentary rock types.

### Example 2

### Saturation Evaluation

An algorithm was developed to automate the S_{W}, porosity, resistivity and TOC calculations using existing or a minimal amount of well log data. Special runs are typically not required when calculating S_{W} using the present algorithm. By plotting resistivity vs. compressional slowness, a regression representing S_{W}=100% is used to determine the R₀ for all non-reservoir rocks. Other plots including porosity, sonic-porosity, and the like may be used for regression analysis dependent upon the data available and accuracy of the measurements. Water saturation for the entire reservoir is calculated using Archie's 1941 calculation. The regression results can be verified using standard measures of distribution, error, and mode. This calculated S_{W} and R₀ can be used in a variety of equations to determine R_{W}, φ, VSH, TOC, Δ Log R, and other related properties.
1. Locate the trend in a crossplot of resistivity vs. compressional slowness that represents the abundant non-hydrocarbon-bearing non-reservoir rock
   (a) Resistivity vs. neutron porosity may also be used
   (b) Resistivity vs. gamma ray may also be used
   (c) Resistivity vs. density may also be used
2. Fit, or regress, a non-linear equation of some form to the resistivity trend that represents the 100% water-saturated resistivity
   (a) Regression may require an initial guess by the interpreter for equation parameters that direct the automated regression process to focus on the appropriate area of the resistivity vs. sonic plot where the S_{W}=100% trend lies
   (b) Or, regression may be accomplished by a preliminary regression using a hyperbolic function where theoretically constrainable endpoints are used to provide the initial estimates for focusing the automated regression (Step 2) of a suitable equation
   (c) Hyperbolic function parameters or the Initial guess in Step 2-a may be derived statistically based on comparing resistivity and compressional slowness statistical distributions with their corresponding crossplot
      (i) Whereby a multiplicity of statistical modes within the resistivity data are used to locate the trend for the automated regression process
      (ii) Whereby a multiplicity of statistical modes within the compressional slowness data are used to locate the trend for the automated regression
3. Use the above empirically-derived final equation to calculate “R₀”, the water-saturated resistivity value for all non-reservoir rocks
4. Calculate water saturation for the entire well using: S_{W}=(R₀/R_{T})^{1/n} where “n” is approximately 2;
5. Verify regression results and calculate S_{W} error by analyzing the statistical distribution of S_{W} and requiring that the final result yield a prominent mode equal to 100%
6. “R₀” is used to compute relative shale volume, VSH where
   (a) Shale and clean reference values are selected from the minimum and maximum statistical modes visible in the distribution of the “R₀” values
7. Rearrange a water saturation equation to solve for porosity (φ)

S_{W}ⁿ=R_{W}/(φ^{m}R_{T})[Archie,1941] (a)

φ=(R_{W}/S_{W}ⁿRₜ)^{1/m} (b)

“n” & “m” ˜2 (c)
thus only R_{W} required to calculate φ
8. R_{W} verified with core porosity data
9. Matrix density or matrix velocity are calculated through a density-porosity or sonic-porosity equation, respectively
10. Matrix values are analyzed in non-shale formations where VSH (Step 6) is less than 50% to identify common matrix values representing the common minerals present in the sedimentary basin where:
   (a) sandstones matrix density≈2.65 to 2.68 g/cc & matrix ΔT≈55.5 to 56.5 μsec/ft,
   (b) limestones matrix density≈2.71 to 2.73 g/cc & matrix ΔT≈51 to 53 μsec/ft,
   (c) dolostones matrix density≈2.78 to 2.85 g/cc & matrix ΔT≈47 to 51 μsec/ft;
11. Steps 9 & 10 are repeated to select an R_{W} value that represents the empirical data;
12. TOC, total organic carbon, is determined by substituting log(R_{T})−log(R₀) into Passey's 1990 equations for “A Log R” and proceeding with the Passy method.
   Variables determined:

(1) R₀: 100% water-saturated resistivity (ohm)

(2) S_{W}: water saturation (decimal)

(3) R_{W}: non-native rock resistivity (ohm)

(4) S_{W}: entire formation

(5) VSH: relative shale volume (decimal)

(6) θ_{T}: total porosity (decimal)

(7) Matrix density (g/cc)

(8) Matrix velocity (μsec/ft)

(9) TOC: total organic carbon in wt %

Using the operations described above provides automated identification of the native S_{W} under 100% resistivity found in non-reservoir, non-source rock. Using the algorithm, any field worker or data collector can calculate the reservoir resistivity without an interpreter, advanced analysis, or other modification of the data. This method does not require tedious calculations or collection of core and log data to determine water saturation in non-reservoir rocks encountered in a well. Calculations are simplified and do not require R_{W}, φ or Archie's “m” value. Further, porosity can be automatically calculated from S_{W} using numerical relationships without extensive well log data, core data, or tedious and complicated calculations.

Since the majority of sedimentary rocks within a sedimentary basin will bear non-reservoir qualities, all non-source rocks will be in their native saturation condition of 100% water filled. By Archie's definition, the main resistivity trend observed on the crossplot represents “R₀” for all non-reservoir, non-source rocks. Any deviations in resistivity in such rocks are the result of decreasing water saturation from the native 100% condition. Therefore, any equation that can be minimized through this trend can be used to compute “R₀” for all non-reservoir, non-source rocks. Once the regression is performed, the produced “R₀” curve is used in the original 1941 Archie observation that Water saturation is equal to a root of the ratio of resistivities R₀ and R_{T} (observed true resistivity). Water saturation derived in this manner eliminated tedious porosity calculations required by conventional methods.

Once S_{W} is obtained, when viewed as a histogram, there should exist a peak, or mode, equal to 100%. If the peak is less than or greater than 100%, the regression is performed again. A statistical relative distribution of the first-pass S_{W} calculation is performed whereby the prominent, most common value (statistical “mode”) is compared to the theoretically expected value of 100%. If it is found to lay to either side of the value 100% beyond an allowable tolerance, the regression of the original equation is performed with an initial guess for the equation's parameters that has been shifted by a positive or negative amount depending on the relative position of the observed, first-pass S_{W} mode.

The error of the final S_{W} calculation is determined by the width or breadth of the Gaussian distribution around the mode representing the native S_{W}=100% condition. Wide distributions equate to greater statistical error while narrow distributions equate to lesser statistical error.

### Example 3

### Robust Model Confirmation

These analyses were conducted in a variety of formation types, in each case the calculated values of saturation, volume, porosity, and TOC were near actual well-bore data based on analysis of core samples, and accurately depicted TOC values that could be used to initiate drilling and production with confidence. In one embodiment, a software algorithm operable to a database containing subterranean formation characteristics, would produce volumetric information for each well including but not limited to, water saturation, porosity, total organic carbon, and shale volume. This demonstrates hydrocarbon content can be accurately determined with a few simple measurements.

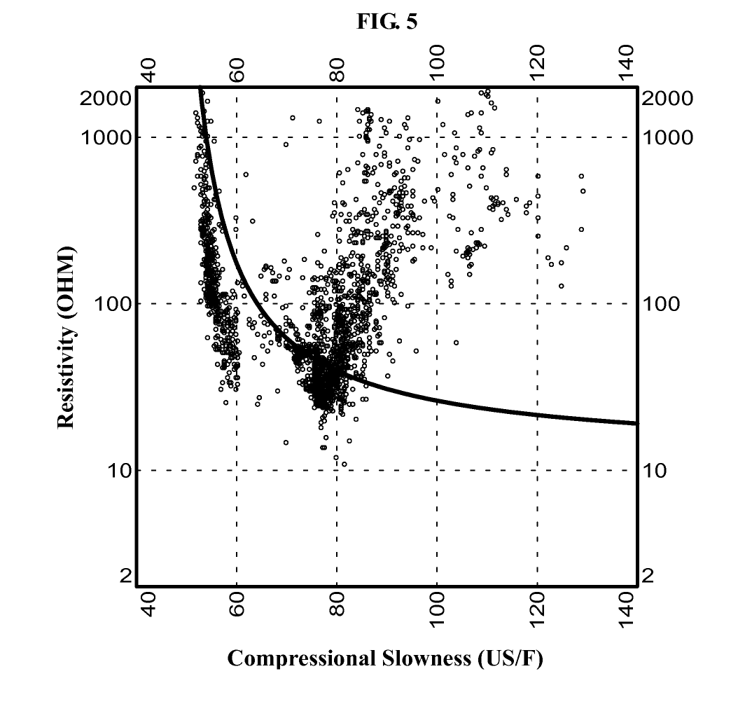

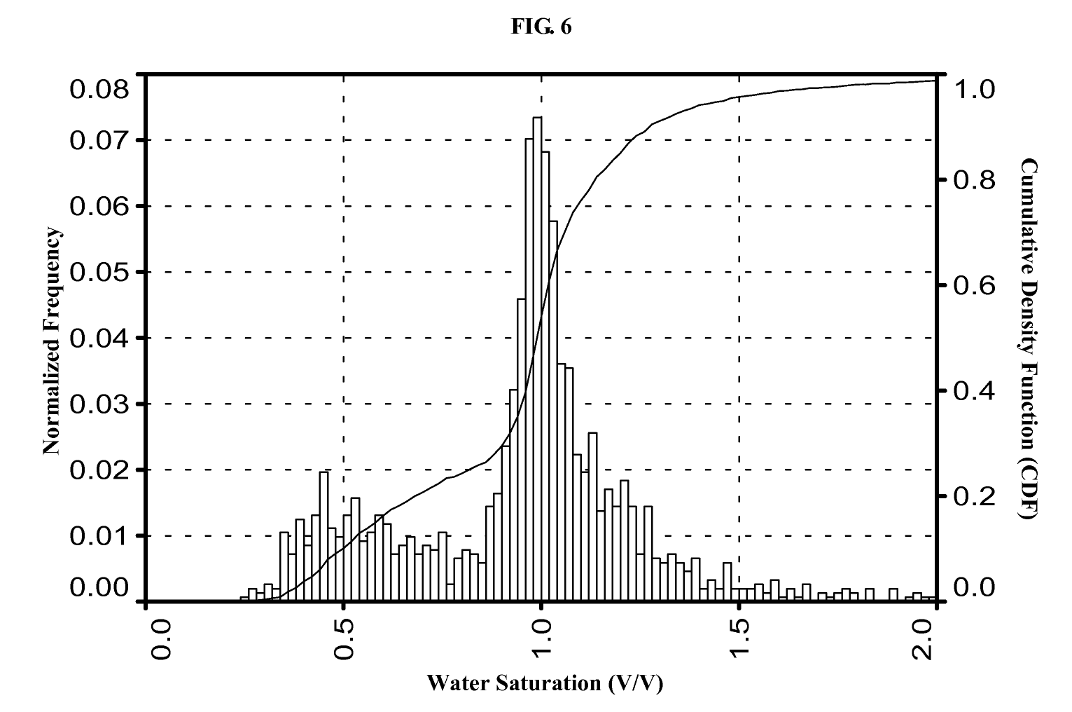

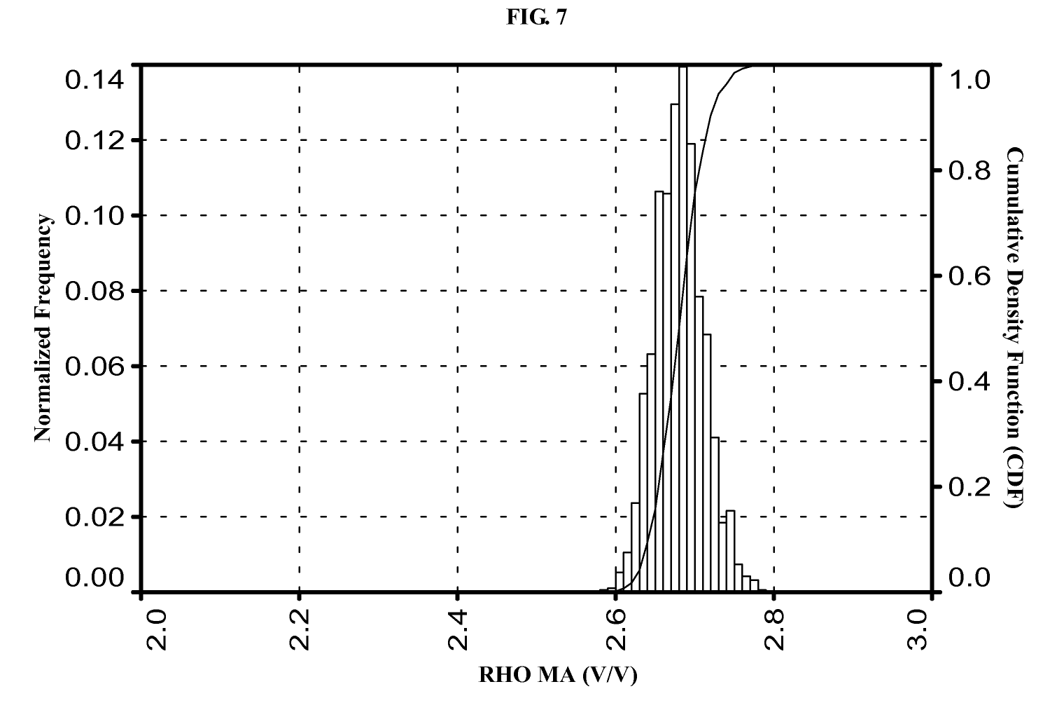

A shale analysis is shown in FIG. 5-7 where the regression analysis (FIG. 5) is used to calculate S_{W}, S_{W} calculation is confirmed (FIG. 6) by the statistical mode peak at S_{W}=100% value, and finally the matrix density (FIG. 7) shows a sandstone peak at approximately 2.67 g/cc. As shown in FIG. 5, regression analysis identifies an accurate value for R₀ when resistivity is plotted against compressional slowness. Regression may be analyzed through a variety of software programs available to those of skill in the art. This method is applicable across a variety of formation media in a variety of different well locations. The accuracy and speed of this method saves time and money by reducing the number and complexity of well log types required to properly analyze the formation properties. Core data agree with the calculated values, further confirming the methods used herein as an accurate assessment of saturation, resistivity, porosity, hydrocarbon content, and volume along with other well properties that may be calculated.

This method is beneficial because it can be used under a variety of source rock conditions to calculate a variety of properties. We have demonstrated that hydrocarbon bulk volume, saturation, porosity, total organic carbon, clay volume, as well as other properties of source rock can be calculated with this method.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. U.S. Pat. No. 3,820,390 (Forgotson) “Method of Recognizing the Presence of Hydrocarbons and Associated Fluids in Reservoir Rocks below the Surface of the Earth” (1974).
2. U.S. Pat. No. 5,557,200 (Coates) “Nuclear Magnetic Resonance Determination of Petrophysical Properties of Geologic Structures” (1996).
3. U.S. Pat. No. 5,668,369 (Oraby) “Method and Apparatus for Lithology-Independent Well Log Analysis of Formation Water Saturation” (1997).
4. U.S. Pat. No. 5,870,690 (Frenkel, et al.) “Joint Inversion Processing Method for Resistivity and Acoustic Well Log Data” (1999).
5. U.S. Pat. No. 5,992,228 (Dunham) “Method for Determining Resistivity Derived Porosity and Porosity Derived Resistivity” (1999).
6. U.S. Pat. No. 6,844,729 (Herron and Herron) “Method of Using Nuclear Spectroscopy Measurements Acquired While Drilling” (2003).
7. U.S. Pat. No. 7,363,164, US2006136135 (Little and Lavigne) “Method of Evaluating Fluid Saturation Characteristics in a Geological Formation” (2006).
8. US20080215242 (Ramakrishnan); “Petrophysical Interpretation of Multipass Array Resistivity Data Obtained While Drilling” (2008).
9. U.S. Pat. No. 7,617,050, US2009043510, WO2009023420 (Allen) “Method for Quantifying Resistivity and Hydrocarbon Saturation in Thin Bed Formations” (2009).
10. Ara, et al., “In-Depth Investigation of the Validity of the Archie Equation in Carbonate Rocks,” SPE Production and Operations Symposium, 24-27 Mar. 2001, Oklahoma City, Okla. (2001).
11. Archie, “The Electrical Resistivity Log as an Aid in Determining Some Reservoir Characteristics” SPE-AIME; (1941).
12. Henderson, “Overlay Water Saturation Model” Henderson Petrophysics website: www.hendersonpetrophysics.com
13. Passey, “A Practical Model for Organic Richness from Porosity and Resistivity Logs” AAPG Bulletin (1990).
14. Pickett, “A review of Current Techniques for Determination of Water Saturation from Logs” SPE, (1966).
15. Pickett “Pattern Recognition as a Means of Formation Evaluation” SPWLA; (1973)
16. Ramakrishnan et al., “Water Cut and Fractional Flow Logs from Array Induction Measurements” SPE 36503, (1996).
17. Shang, et al., “Improved Water Saturation Estimation Using Equivalent Rock Element Model and Application to Different Rock Types,” Europec/EAGE Conference and Exhibition, 9-12 Jun. 2008, Rome, Italy (2008).
18. Worthington, “The Evolution of Shaly Sand Concepts in Reservoir Evaluation” The Log Analyst (1985).

1. A computer readable medium for processing well log data comprising:
a) fit a trend in a crossplot of resistivity against one or more formation parameters to obtain 100% water-saturated resistivity (R₀),
b) automated regression process for resistivity against a porosity log to determine 100% saturation (S_{W}=100%),
c) calculate water saturation for the entire well using S_{W}=(R₀/R_{T})^{1/n},
d) verify regression results and S_{W} error where S_{W} yields a prominent mode equal to 100%,
e) compute shale volume (VSH) from R₀,
f) solve for porosity (φ) where φ=(R_{W}/S_{W}ⁿ R_{T})^{1/m},
g) determine R_{W},
h) identify common matrix values representing the common minerals present in sedimentary basins, and
i) determine total organic carbon.

2. The computer readable medium of claim 1, wherein matrix values for R_{W} (g) are analyzed in non-shale formations where VSH is less than 50%.

3. The computer readable medium of claim 1, wherein the formation is selected from the group consisting of sandstones with a matrix density and velocity of about 2.65 to 2.68 g/cc and 55.5 to 56.5 μsec/ft, limestones with a matrix density and velocity of about 2.71 to 2.73 g/cc and 51 to 53 μsec/ft, and dolostones with a matrix density and velocity in the range of 2.78 to 2.85 g/cc and 47 to 51 pec/ft.

4. The computer readable medium of claim 1, wherein (e) and (f) are repeated to select an R_{W} value within an expected values.

5. The computer readable medium of claim 1, wherein said crossplot (a) is selected from the group consisting of resistivity against compressional slowness, resistivity against neutron porosity, resistivity against density, and resistivity against NMR.

6. The computer readable medium of claim 1, wherein said regression (b) is a preliminary regression using a constrained hyperbolic function.

7. The computer readable medium of claim 6, wherein the hyperbolic function parameters are derived statistically from resistivity and compressional slowness statistical distributions with their corresponding crossplot.

8. The computer readable medium of claim 1, wherein shale and clean reference values are selected from the minimum and maximum statistical modes visible in the distribution of the “R₀” values.

9. The computer readable medium of claim 1, wherein R_{W} is determined by fitting core data, solving the density-porosity equation for matrix density, or solving a sonic-porosity equation for matrix velocity.

10. A method for determining well log parameters comprising:
a) fit a trend in a crossplot of resistivity against one or more formation parameters to obtain 100% water-saturated resistivity (R₀),
b) automated regression process for resistivity against a porosity log to determine 100% saturation (S_{W}=100%),
c) calculate water saturation for the entire well using S_{W}=(R₀/R_{T})^{1/n},
d) verify regression results and S_{W} error where S_{W} yields a prominent mode equal to 100%,
e) compute relative shale volume (VSH) from R₀,
f) solve for porosity (φ) where φ=(R_{W}/S_{W}ⁿ R_{T})^{1/m},
g) determine R_{W},
h) identify common matrix values representing the common minerals present in sedimentary basins, and
i) determine total organic carbon.

11. The method of claim 10, wherein matrix values (g) are then analyzed in non-shale formations where VSH is less than 50%.

12. The method of claim 10, wherein the formation is selected from the group consisting of sandstones with a matrix density and velocity of about 2.65 to 2.68 g/cc and 55.5 to 56.5 μsec/ft, limestones with a matrix density and velocity of about 2.71 to 2.73 g/cc and 51 to 53 μsec/ft, and dolostones with a matrix density and velocity in the range of 2.78 to 2.85 g/cc and 47 to 51 μsec/ft.

13. The method of claim 10, wherein (e) and (f) are repeated to select an R_{W} value within an expected values.

14. The method of claim 10, wherein said crossplot (a) is selected from the group consisting of resistivity against compressional slowness, resistivity against neutron porosity, resistivity against density, and resistivity against NMR.

15. The method of claim 10, wherein said regression (b) is a preliminary regression using a constrained hyperbolic function.

16. The method of claim 15, wherein the hyperbolic function parameters are derived statistically from resistivity and compressional slowness statistical distributions with their corresponding crossplot.

17. The method of claim 10, wherein shale and clean reference values are selected from the minimum and maximum statistical modes visible in the distribution of the “R₀” values.

18. The method of claim 10, wherein R_{W} is determined by fitting core data, solving the density-porosity equation for matrix density, or solving a sonic-porosity equation for matrix velocity.
